(19) United States
(12) Patent Application Publication
(10) Pub. No.: US 2021/0001782 A1
(43) Pub. Date: Jan. 7, 2021

(54) CAR PHONE HOLDER

(71) Applicant: Wing Tak Lee Silicone Rubber Technology (Shenzhen) Co., Ltd., Shenzhen (CN)

(72) Inventor: Tak Nam LIU, Shenzhen (CN)

(21) Appl. No.: 16/844,140

(22) Filed: Apr. 9, 2020

(30) Foreign Application Priority Data
Jul. 3, 2019 (CN) 2019105955990

(51) Int. Cl. B60R 11/02

(52) U.S. Cl. CPC B60R 11/0241; B60R 2011/0008

(57) ABSTRACT

A car phone holder, comprising: a front case, a rear case, a fixing portion, a rotating portion, a side clamping portion and a lower clamping portion provided between the front case and the rear case, wherein the side clamping portion and the lower clamping portion are unfolded when the mobile phone is clamped, and are folded when the mobile phone is not clamped; the fixing portion is clamped and fixed with the air outlet of the vehicle air conditioner, the fixed side of the rotating portion is fixedly connected with the fixing portion, and the rotational side of the rotating portion is fixedly connected with the rear case.

### CROSS REFERENCE TO RELATED APPLICATION

The present application claims priority to Chinese patent application No. 201910595599.0, entitled “CAR PHONE HOLDER”, filed on Jul. 3, 2019, the entire content of which is incorporated herein by reference.

### TECHNICAL FIELD

The present application relates to the field of electronic accessories, and in particular to a car phone holder.

### BACKGROUND

With the widespread application of electronic devices (such as mobile phones, tablet computers, etc.), the electronic devices can support more and more applications, have more and more powerful functions, and are developing towards the direction of diversification and personalization, becoming indispensable electronic products in people's lives.

Using mobile phone in car has become an essential requirement for car owner, but the existing car phone bracket has a large volume, which takes up too much space when not in use, and the existing car phone bracket is clamped at the air outlet of the air conditioner, when it is not used, the excessive volume will affect the air-conditioning effect of the air conditioner and the user experience.

### SUMMARY

The embodiments of the present application provide a car phone holder, which has the advantage of small volume when not in use, thereby having a small influence on the air-conditioning effect of the air conditioner and improving the user experience.

The first embodiment of the present application provides a car phone holder, comprising:

a front case, a rear case, a fixing portion, a rotating portion, a side clamping portion and a lower clamping portion provided between the front case and the rear case, wherein the side clamping portion and the lower clamping portion are unfolded when the mobile phone is clamped, and are folded when the mobile phone is not clamped; the fixing portion is clamped and fixed with the air outlet of the vehicle air conditioner, the fixed side of the rotating portion is fixedly connected with the fixing portion, and the rotational side of the rotating portion is fixedly connected with the rear case.

The embodiments of the present application have the following beneficial effects:

it can be seen that the car phone holder provided by the technical solution of the present application has the front case, the rear case, the side clamping portion and the lower clamping portion provided between the front case and the rear case, the side clamping portion and the lower clamping portion are unfolded when the mobile phone is clamped, and are folded when the mobile phone is not clamped, so that when not in use, the volume of the car phone holder is small, which reduces the influence of the air volume on the air outlet of the air conditioner, and improves the user experience. In addition, the rotating portion provided in the present application can adjust an arbitrary angle, which makes the car phone holder very convenient when in use.

### BRIEF DESCRIPTION OF THE DRAWINGS

In order to more clearly illustrate the technical solutions in the embodiments of the present application, drawings used in the description of the embodiments will be briefly described below, obviously, the drawings in the following description are some embodiments of the present application, those of ordinary skill in the art can also obtain other drawings based on these drawings without any creative efforts.

FIG. 1 is a schematic structural diagram of a car phone holder according to an embodiment of the present application.

FIG. 2 is another schematic structural diagram of a car phone holder provided by the present application.

FIG. 3 is a schematic structural diagram of a lower clamping portion provided by the present application.

FIG. 4 is a schematic structural diagram of a side clamping portion provided by the present application.

FIG. 5 is a schematic structural diagram of a damping member provided by the present application.

FIG. 6 is a schematic cross-sectional view of a damping rod provided by the present application.

FIG. 7 is a schematic structural diagram of a car phone holder provided by the present application.

### DESCRIPTION OF THE EMBODIMENTS

The technical solution in the embodiments of the present application is clearly and completely described below with reference to the accompanying drawings in the embodiments of the present application, obviously, the described embodiments are a part of the embodiments of the present application, rather than all of the embodiments. All other embodiments obtained by those of ordinary skill in the art based on the embodiments of the present application without paying any creative efforts are within the scope of protection of the present application.

The terms, such as “first”, “second”, “third”, “fourth”, etc., in the specification, claims and the accompanying drawings of the present application are used to distinguish different objects, and are not intended to describe a specific order. Furthermore, the terms “comprise”, “have” and any variations thereof are intended to cover a non-exclusive inclusion. For example, a process, method, system, product, or device that comprises a series of steps or units is not limited to the listed steps or units, but alternatively comprises steps or units that are not listed, or alternatively comprises other steps or units inherent to these processes, methods, products or devices.

References to “an embodiment” herein mean that a particular feature, structure, or characteristic described in connection with the embodiments can be included in at least one embodiment of the present application. The appearances of the phrase in various places in the specification are not necessarily referring to the same embodiments, and are not exclusive or alternative embodiments that are mutually exclusive from other embodiments. Those skilled in the art will explicitly and implicitly understand that the embodiments described herein can be combined with other embodiments.

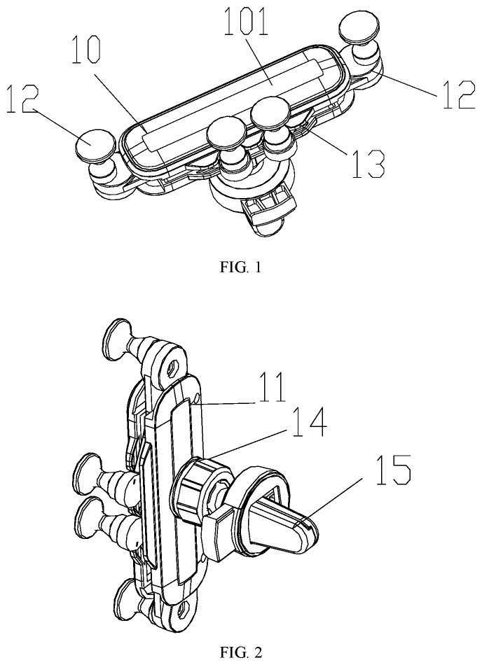

Referring to FIG. 1 and FIG. 2, the present application provides a car phone holder, as shown in FIG. 1 and FIG. 2, the car phone holder comprises: a front case 10, a rear case 11, a fixing portion 15, a rotating portion 14, a side clamping portion 12 and a lower clamping portion 13 provided between the front case 10 and the rear case 11, wherein the side clamping portion 12 and the lower clamping portion 13 are unfolded when the mobile phone is clamped, and are folded when the mobile phone is not clamped; the fixing portion is clamped and fixed with the air outlet of the vehicle air conditioner, the fixed side of the rotating portion 14 is fixedly connected with the fixing portion 15, and the rotational side of the rotating portion 14 is fixedly connected with the rear case 11.

The car phone holder provided by the technical solution of the present application has the front case, the rear case, the side clamping portion and the lower clamping portion provided between the front case and the rear case, the side clamping portion and the lower clamping portion are unfolded when the mobile phone is clamped, and are folded when the mobile phone is not clamped, so that when not in use, the volume of the car phone holder is small, which reduces the influence of the air volume on the air outlet of the air conditioner, and improves the user experience. In addition, the rotating portion provided in the present application can adjust an arbitrary angle, which makes the car phone holder very convenient when in use.

Alternatively, an airbag 101 is further provided on the outer surface of the front case 10. The airbag 101 can play a role of damping the mobile phone during driving.

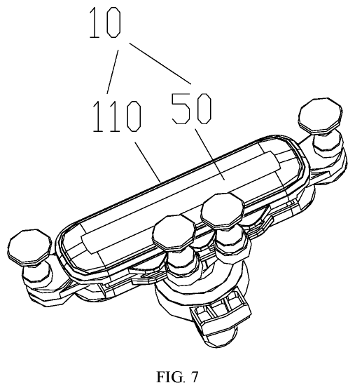

In another alternative embodiment, the present application further provides a front case 10 of the car phone holder, as shown in FIG. 7, a damping member 50 is further provided on the outer surface of the front case, the damping member 50 is fixedly connected to the outer frame body 110 of the front case.

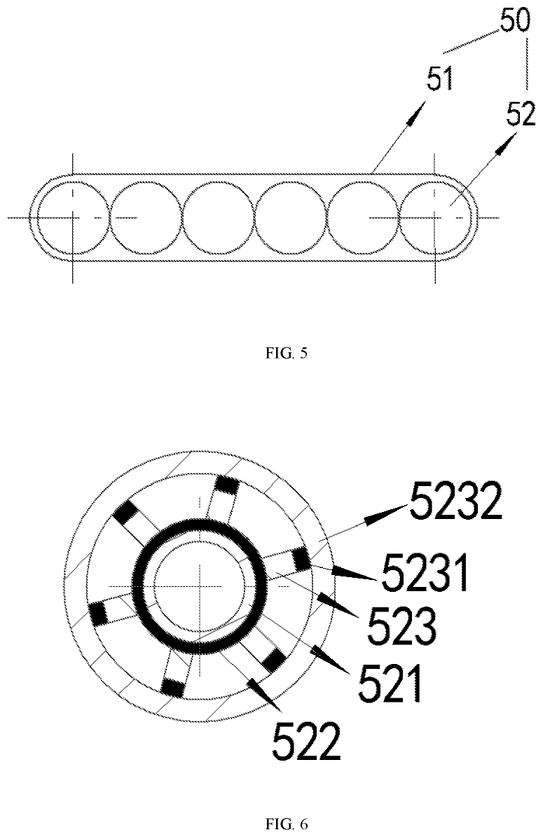

Alternatively, a damping member 50 is further provided on the outer surface of the front case 10, and as shown in FIG. 5, the damping member 50 comprises: an outer wrap 51 and a plurality of damping rods 52 disposed in the outer wrap 51, as shown in FIG. 6, the damping rod 52 may comprise: an inner supporting cylinder 521, an inner silicone layer 522 and a supporting rod 523; wherein the inner silicone layer 522 is attached and fixed to the outer surface of the inner supporting cylinder 521, and the supporting rod 523 is fixed to the outer surface of the inner silicone layer 522, the head of the supporting rod 523 is provided with a silicone head 5231, the outer surface of the silicone head 5231 is wrapped with a wrap 5232 (the wrap 5232 may also be made of a cloth material), the supporting rod 523 and the inner supporting cylinder 521 may be made of hard rubber materials.

The principle of realizing the beneficial effects of the embodiments of the present application is that, for a car phone holder, it may be used in extreme conditions, such as a severe impact, so it requires both a certain strength and a large buffer for the shock absorption of the car phone holder, in some extreme cases, it is possible to crush the airbag setting the airbag separately for shock absorption, and then cause the entire car phone holder to be scrapped, so that for the damping member 50, it is provided with multiple damping rods, and the multiple damping rods can decompose the pressure well, in addition, the above-mentioned damping rod has a solid structure, and it will not break no matter how much pressure is applied, and has good stability, in addition, the present application provides a two-layer shock-absorbing structure, the first layer is a silicone material provided on the head of the supporting rod 523, and the second layer is an inner silicone layer 522, in this way, the two-layer shock-absorbing structure can well damp the mobile phone and has the advantage of good shock-absorbing effect.

Referring to FIG. 3, as shown in FIG. 3, the lower clamping portion 13 may comprise two clamping bodies 131, and the clamping body 131 may comprise: a cantilever 1311, a base 1312, a connecting seat 1313 and a blocking ball 20, wherein one end of the cantilever 1311 is fixed to the base 1312, and the other end is fixed to the connecting seat 1313, the blocking ball 20 is fixedly disposed on the upper end of the base 1312, the connecting seat 1313 is fixedly matched with a side base 121 of the side clamping portion 12 and the connecting base 1313 can rotate along the side base 121, and the connecting seat 1313 is fixedly matched with the side base 121 of the side clamping portion 12 to form an arc-shaped notch 21, the cantilever 1311 passes through the arc-shaped notch 21, and the size of the arc-shaped notch 21 is greater than that of the cantilever 1311.

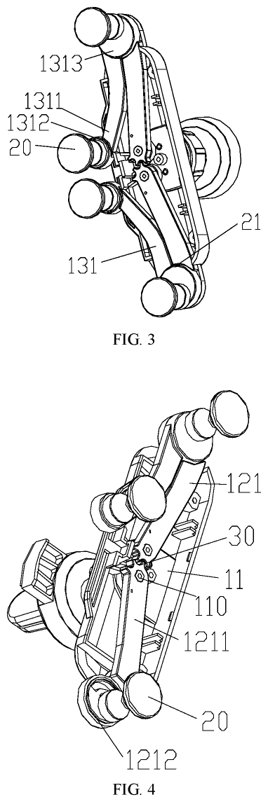

Referring to FIG. 4, as shown in FIG. 4, the side clamping portion 12 may comprise two transverse bodies 121, the transverse body 121 may comprise: a transverse cantilever 1211, a side base 1212 and a blocking ball 20, wherein one end of the transverse cantilever 1211 is fixedly connected to the side base 1212, which is fixedly connected to the blocking ball 20, the other end of the transverse cantilever 1211 is provided with a half gear 30, half gears 30 of two transverse cantilever 1211 gear match, the other end of the transverse cantilever 1211 is further provided with a hole connected with a protruding portion 110 of the rear case 11, and the transverse cantilever 1211 can rotate along the protruding portion 110.

Referring to FIG. 3 and FIG. 4, when not in use, the lower clamping portion and the side clamping portion are folded, and at this time the volume is the smallest, when clamping, the mobile phone contacts the lower clamping portion, and after the blocking ball is forced, the blocking ball drives the cantilever downward, and the cantilever drives the side base 121 to rotate forward, when the cantilever rotates to one edge of the arc-shaped notch, the side base cannot rotate due to the blocking of the edge of the arc-shaped notch, at this time, the force is transmitted to the side base of the side clamping portion, the side base drives the transverse cantilever downward, the other end of the transverse cantilever rotates forward along the protruding portion, after the half gear rotates to a setting position, the cogging of the half gear is fixed to each other; when not clamping, the blocking ball is under no force, the blocking ball drives the cantilever upward, and the cantilever drives the side base to rotate in the reverse direction, when the cantilever rotates to the other edge of the arc-shaped notch, the side base cannot rotate due to the blocking of the edge of the arc-shaped notch, at this time, the force is transmitted to the side base of the side clamping portion, the side base drives the transverse cantilever upward, and the other end of the transverse cantilever rotates in the opposite direction along the protruding portion and retracts.

Alternatively, the outer surface of the above-mentioned blocking ball 20 may comprise a silicone layer, and after the silicone layer is provided, damage to the mobile phone can be avoided.

Alternatively, the contact surface between the fixing portion 15 and the air outlet of the vehicle air conditioner is provided with a silica gel, the silica gel also avoids damage to the air outlet of the vehicle air conditioner.

The embodiments of the present application have been described in detail above, specific embodiments are used in this document to explain the principles and implementation of the present application, the descriptions of the above embodiments are only used to help understand the method and core ideas of the present application; at the same time, persons of ordinary skill in the art may change the specific implementation and application scope according to the idea of the present application, in summary, the content of the present description should not be construed as a limitation on the present application.

What is claimed is:

1. A car phone holder comprising:
a front case, a rear case, a fixing portion, a rotating portion, and a side clamping portion as well as a lower clamping portion provided between the front case and the rear case, wherein the side clamping portion and the lower clamping portion are unfolded when a mobile phone is clamped, and are folded when the mobile phone is not clamped; the fixing portion is configured to be clamped and fixed on the air outlet of the vehicle air conditioner, the fixed side of the rotating portion is fixedly connected with the fixing portion, and the rotational side of the rotating portion is fixedly connected with the rear case.

2. The car phone holder of claim 1, wherein the outer surface of the front case is provided with an airbag.

3. The car phone holder of claim 1, wherein the lower clamping portion comprises two clamping bodies, and each of the two clamping bodies comprises: a cantilever, a base, a connecting seat and a blocking ball, wherein one end of the cantilever is fixed to the base, and the other end is fixed to the connecting seat, the blocking ball is fixedly disposed on the upper end of the base, the connecting seat is fixedly matched with a side base of the side clamping portion and the connecting base is capable of rotating along the side base, and the connecting seat is fixedly matched with the side base of the side clamping portion to form an arc-shaped notch, the cantilever passes through the arc-shaped notch, and the size of the arc-shaped notch is greater than that of the cantilever.

4. The car phone holder of claim 1, wherein the side clamping portion comprises two transverse bodies, each of the two transverse bodies comprises: a transverse cantilever, a side base and a blocking ball, wherein one end of the transverse cantilever is fixedly connected to the side base, which is fixedly connected to the blocking ball, the other end of the transverse cantilever is provided with a half gear, half gears of two transverse cantilever gear match, the other end of the transverse cantilever is further provided with a hole connected with a protruding portion of the rear case, and the transverse cantilever is capable of rotating along the protruding portion.

5. The car phone holder of claim 4, wherein the outer surface of the blocking ball comprises a silicone layer.

6. The car phone holder of claim 1, wherein the contact surface between the fixing portion and the air outlet of the vehicle air conditioner is provided with a silica gel.
